(19) United States
(12) Patent Application Publication
(10) Pub. No.: US 2020/0178751 A1
(43) Pub. Date: Jun. 11, 2020

(54) ELECTRIC VACUUM CLEANING APPARATUS

(71) Applicant: Toshiba Lifestyle Products & Services Corporation, Kawasaki-shi (JP)

(72) Inventors: Hironori Sasaki, Nagoya (JP); Takahiro Murosaki, Owariasahi (JP)

(73) Assignee: Toshiba Lifestyle Products & Services Corporation, Kawasaki-shi (JP)

(21) Appl. No.: 16/680,721

(22) Filed: Nov. 12, 2019

(30) Foreign Application Priority Data
Dec. 7, 2018 (JP) 2018-230035

(51) Int. Cl. A47L 11/40; A47L 9/28; C02F 1/461; A47L 11/20

(52) U.S. Cl. CPC A47L 11/4083; A47L 11/201; C02F 1/4618; A47L 9/28

(57) ABSTRACT

To provide an electric vacuum cleaning apparatus that can disinfect the surface to be cleaned by atomizing electrolyzed water containing hypochlorous acid and spraying or spreading the atomized electrolyzed water to this surface while moving on this surface. The electric vacuum cleaning apparatus includes: an electric blower that generates suction vacuum pressure; a suction air passage equipped with a suction port and fluidly connected to a suction side of the electric blower; an electrolyzed-water generator that electrolyzes water to produce electrolyzed water containing hypochlorous acid; and an atomizer that atomizes the electrolyzed water produced by the electrolyzed-water generator and supplies the atomized electrolyzed water to a surface to be cleaned.

### CROSS-REFERENCE TO RELATED APPLICATIONS

This application claims the benefit of priority of Japanese Patent Application No. 2018-230035, filed on Dec. 7, 2018, the entire contents of which are incorporated herein by reference.

### BACKGROUND OF THE INVENTION

### Field of the Invention

Embodiments according to the present invention relate to an electric vacuum cleaning apparatus.

### Description of the Related Art

A known mobile autonomous robot includes: a hypochlorous-acid-water supply unit for supplying hypochlorous acid to an object to be treated; a chemical sensor for detecting a substance to be treated and/or an image recognition means for recognizing the substance to be treated; a moving means; and a determination means for determining (i) an object and a place to which hypochlorous acid is supplied and (ii) a means, amount, and time by which hypochlorous acid is supplied, on the basis of information detected by the chemical sensor and/or information obtained from the image recognition means (for example, JP 2017-169613 A).

A conventional vacuum cleaner removes dust on the surface to be cleaned by sucking in the dust. In this case, in general, the user of the vacuum cleaner moves the vacuum cleaner to everywhere on the surface to be cleaned.

### SUMMARY OF THE INVENTION

In view of the above-described circumstance, it is an object of the present invention to provide an electric vacuum cleaning apparatus that can disinfect the surface to be cleaned by atomizing electrolyzed water containing hypochlorous acid and spraying or spreading the atomized electrolyzed water to this surface while moving on this surface.

To achieve the above object, an electric vacuum cleaning apparatus includes: an electric blower that generates suction vacuum pressure; a suction air passage equipped with a suction port and fluidly connected to a suction side of the electric blower; an electrolyzed-water generator that electrolyzes water to produce electrolyzed water containing hypochlorous acid; and an atomizer that atomizes the electrolyzed water produced by the electrolyzed-water generator and supplies the atomized electrolyzed water to a surface to be cleaned.

### BRIEF DESCRIPTION OF THE DRAWINGS

FIG. 1 is a perspective view illustrating an electric vacuum cleaning apparatus according to one embodiment of the present invention.

FIG. 2 is a schematic diagram mainly illustrating air passages and its peripheral components of the electric vacuum cleaning apparatus shown in FIG. 1.

FIG. 3 is a perspective view illustrating an electric vacuum cleaning apparatus according to another embodiment of the present invention.

### DETAILED DESCRIPTION

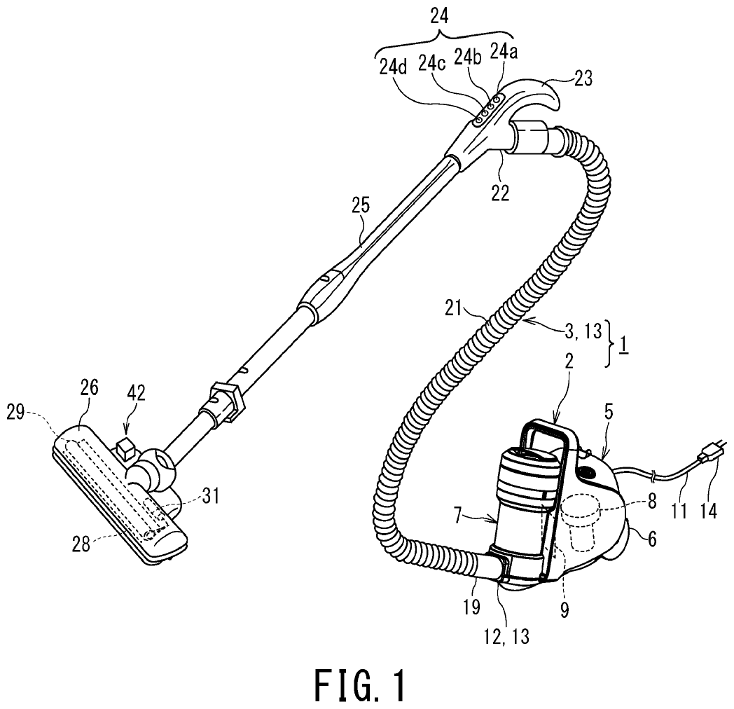

A description will now be given of embodiments of electric vacuum cleaning apparatuses according to the present invention by referring to FIG. 1 to FIG. 3. The same reference signs are given for identical or equivalent components in each figure.

FIG. 1 is a perspective view of an electric vacuum cleaning apparatus 1 according to one embodiment of the present invention.

The electric vacuum cleaning apparatus 1 according to the present embodiment is, for example, a canister type electric vacuum cleaner.

The electric vacuum cleaning apparatus 1 is not limited to the canister type electric vacuum cleaner. The electric vacuum cleaning apparatus 1 may be configured as an upright type, a stick type, or a handy type electric vacuum cleaner. Further, the electric vacuum cleaning apparatus 1 may be an autonomous vacuum cleaner capable of moving on the surface to be cleaned by autonomous control.

The electric vacuum cleaning apparatus 1 includes a cleaner body 2 capable of moving on the surface to be cleaned and a hose 3 detachably connected to the cleaner body 2. The hose 3 is fluidly connected to the cleaner body 2. A user can move the cleaner body 2 by pulling the hose 3.

The cleaner body 2 includes: a body housing 5; a pair of wheels 6 provided on the respective right and left sides of the body housing 5; a dust separation device 7 detachably attached to the body housing 5; an electric blower 8 accommodated in the body housing 5; a cleaner controller 9 mainly for controlling the electric blower 8; and a power cord 11 for leading power to the electric blower 8.

The cleaner body 2 drives the electric blower 8 by using the power supplied through the power cord 11. The cleaner body 2 applies negative pressure generated by driving the electric blower 8 to the hose 3. The electric vacuum cleaning apparatus 1 sucks in dust-containing air from the surface to be cleaned through the hose 3, separates the dust from the inhaled dust-containing air, collects and accumulates the dust after separation, and exhausts the clean air from which the dust has been removed.

The body housing 5 includes a connection port 12 corresponding to the suction port of the cleaner body 2. The connection port 12 is a coupling joint to/from which the hose 3 can be attached and detached. The connection port 12 fluidly connects the hose 3 to the dust separation device 7. The connection port 12 enables easy attachment and detachment of the hose 3 to/from the cleaner body 2. The connection port 12 opens toward the front of the body housing 5. Further, the connection port 12 is disposed on the centerline extending in the front-rear direction or straight advance direction of the cleaner body 2. Thus, a user can move the electric vacuum cleaning apparatus 1 as intended by pulling the hose 3.

The right and left wheels 6 support the cleaner body 2 such that the cleaner body 2 can move on the surface to be cleaned. The wheels 6 are arranged such that the centerline of rotation of the right wheel 6 substantially matches the centerline of rotation of the left wheel 6. Thus, the user can pull the hose 3 so as to smoothly advance the cleaner body 2 and turn it to the right or left.

The dust separation device 7 separates, collects, accumulates the dust from the dust-containing air, which flows into the cleaner body 2 from the connection port 12 or the hose 3, and sends the clean air from which dust has been removed to the electric blower 8. The dust separation device 7 is a separation device that separates dust from dust-containing air by, for example, centrifugation (cyclone separation). The dust separation device 7 may be another type of separation device that separates dust from dust-containing air with a filter for filtering and collecting dust (for example, a dust collection bag such as a so-called paper duct bag) under the straight-flow type separation, in which dust is separated from air by difference in inertia force between dust and air going straight.

The electric blower 8 is driven by the power supplied through the power cord 11. The electric blower 8 sucks in air from the dust separation device 7 so as to generate suction vacuum pressure. The air passage that reaches the suction side of the electric blower 8 from the connection port 12 through the dust separation device 7 is part of the suction air passage 13 fluidly connected to the suction side of the electric blower 8.

The cleaner controller 9 mainly adjusts start, stop, and output of the electric blower 8. The cleaner controller 9 includes a microprocessor and a storage device for storing, for example, parameters and various operation programs executed with the microprocessor. The storage device stores various settings (arguments) related to a plurality of preset operation modes. The operation modes are related to the output of the electric blower 8. Different input values, i.e., input values of the electric blower 8 and current values flowing to the electric blower 8 are set for each operation mode. Each operation mode is associated with a user's operation received with the hose 3. The cleaner controller 9 alternatively selects an arbitrary operation mode corresponding to the user's operation received with the hose 3 from the preset operation modes, and reads out the selected operation mode from the storage device so as to drive the electric blower 8 on the basis of the settings of the operation mode having been read out.

The power cord 11 supplies power to the cleaner body 2 from a plug-in connector for wiring or a so-called power outlet. At the free end of the power cord 11, an attachment plug 14 is provided. The electric vacuum cleaning apparatus 1 may be a so-called cordless type in which the cleaner body 2 is provided with a power source, for example, a rechargeable battery.

The hose 3 is part of the suction air passage 13 fluidly connected to the suction side of the electric blower 8.

The hose 3 sucks in dust-containing air from the surface to be cleaned by the negative pressure that acts from the cleaner body 2, and leads the dust-containing air to the cleaner body 2. The hose 3 includes: a connecting tube 19 as a joint detachably connected to the cleaner body 2; a dust collecting hose 21 fluidly connected to the connecting tube 19; a hand operation tube 22 fluidly connected to the dust collecting hose 21; a grip 23 protruding from the hand operation tube 22; an input unit 24 provided on the grip 23; an extension tube 25 detachably connected to the hand operation tube 22; and a cleaning head 26 detachably connected to the extension tube 25.

The connecting tube 19 is the joint that is attachable to and detachable from the connection port 12, and is fluidly connected to the dust separation device 7 through the connection port 12. The connection pipe 19 enables easy attachment and detachment of the hose 3 to/from the cleaner body 2.

The dust collecting hose 21 is a long, flexible, and substantially cylindrical hose. One end (i.e., the rear end in this case) of the dust collecting hose 21 is fluidly connected to the connecting tube 19. The dust collecting hose 21 is fluidly connected to the dust separation device 7 through the connecting tube 19. A user can direct the hand operation tube 22, the extension tube 25, and the cleaning head 26 in any direction with the flexible dust collecting hose 21.

The hand operation tube 22 relays the dust collecting hose 21 and the extension tube 25. One end (i.e., the rear end in this case) of the hand operation tube 22 is fluidly connected to the other end (i.e., the front end in this case) of the dust collecting hose 21. The hand operation tube 22 is fluidly connected to the dust separation device 7 through the dust collecting hose 21 and the connecting tube 19.

The grip 23 is a portion to be gripped by a user's hand for operating the electric vacuum cleaning apparatus 1. The grip 23 protrudes from the hand operation tube 22 in an appropriate shape that can be easily grasped by the user's hand. A user can direct the extension tube 25 and the cleaning head 26 in any direction by holding the grip 23.

The input unit 24 includes switches corresponding to the respective operation modes. For example, the input unit 24 includes: a stop switch 24a corresponding to the operation of stopping the electric blower 8; a start switch 24b corresponding to the operation of starting the electric blower 8; a brush switch 24c corresponding to power supply and power shutoff with respect to the cleaning head 26; and a sterilization switch described below. The stop switch 24a and the start switch 24b transmit an operation signal to the cleaner controller 9 by wire or wirelessly. A user of the electric vacuum cleaning apparatus 1 can operate the input unit 24 to alternatively select one of the operation modes of the electric blower 8. The start switch 24b also functions as a selecting switch of the operation modes during operation of the electric blower 8. In this case, each time the cleaner controller 9 receives an operation signal from the start switch 24b, the cleaner controller 9 switches the operation mode in order of strong→medium→weak→strong→medium→weak→ . . . . Instead of the start switch 24b, the input unit 24 may be individually provided with a strong-mode operation switch, a medium-mode operation switch, and a weak-mode operation switch.

The extension tube 25 has a telescopic structure in which a plurality of tubular bodies are superimposed, and can be expanded and contracted. A joint structure is provided at one end (i.e., the rear end in this case) of the extension tube 25, and this joint structure is detachable with respect to the other end (i.e., the front end in this case) of the hand operation tube 22. The extension tube 25 is fluidly connected to the dust separation device 7 through the hand operation tube 22, the dust collecting hose 21, and the connecting tube 19. A user can appropriately cope with the height and width of the place to be cleaned by expanding or contracting the extension tube 25.

The cleaning head 26 can run or slide on the surface to be cleaned such as a wooden floor and a carpet. The cleaning head 26 has a bottom face that faces the surface to be cleaned in a running state or a sliding state. On this bottom face of the cleaning head 26, a suction port 28 is provided. The cleaning head 26 includes a rotatable brush 29 arranged at the suction port 28 and an electric motor 31 for rotatably driving the rotatable brush 29. A joint structure is provided on one end (i.e., the rear end in this case) of the cleaning head 26, and this joint structure is attachable to and detachable from the other end (i.e., the front end in this case) of the extension tube 25. The cleaning head 26 is fluidly connected to the dust separation device 7 through the extension tube 25, the hand operation tube 22, the dust collecting hose 21, and the connecting tube 19. That is, the cleaning head 26, the extension tube 25, the hand operation tube 22, the dust collecting hose 21, the connecting tube 19, and the dust separation device 7 constitute the suction air passage 13 from the suction port 28 to the electric blower 8. Each time the electric motor 31 receives the operation signal from the brush switch 24c, the electric motor 31 alternately repeats the operation start and the operation stop.

In addition, the cleaning head 26 is provided with an electrolyzed-water generator 42 that electrolyzes water to produce electrolyzed water containing hypochlorous acid. The input unit 24 includes a sterilization switch 24d that receives an operation to switch between permission and non-permission of generating electrolyzed water. The electric vacuum cleaning apparatus 1 sterilizes (i.e., disinfects) the surface to be cleaned by spraying or spreading the electrolyzed water containing hypochlorous acid to this surface while moving on the surface to be cleaned.

When the start switch 24b is operated, the electric vacuum cleaning apparatus 1 starts up the electric blower 8. For example, when the start switch 24b is operated when the electric blower 8 is stopped, first, the electric vacuum cleaning apparatus 1 starts the electric blower 8 in the strong operation mode. When the start switch 24b is operated again in the strong operation mode, the electric vacuum cleaning apparatus 1 switches the operation mode of the electric blower 8 to the medium operation mode. When the start switch 24b is operated three times, the electric vacuum cleaning apparatus 1 switches the operation mode of the electric blower 8 to the weak operation mode. In this manner, every time the start switch 24b is operated, the above-described mode switching is repeated. The strong operation mode, the medium operation mode, and the weak operation mode are predetermined operation modes. The input value to the electric blower 8 is the largest in the strong operation mode and is the smallest in the weak operation mode. The electric blower 8 having started up sucks in air from the dust separation device 7 so as to bring the inside of the dust separation device 7 into a negative pressure state.

The negative pressure inside the dust separation device 7 sequentially passes through the connection port 12, the connecting tube 19, the dust collecting hose 21, the hand operation tube 22, the extension tube 25, and the cleaning head 26 so as to act on the suction port 28. The electric vacuum cleaning apparatus 1 sucks in the dust on the surface to be cleaned together with the air by the negative pressure acting on the suction port 28. The dust separation device 7 separates, collects, and accumulates the dust from the dust-containing air having been sucked into the electric vacuum cleaning apparatus 1, and sends the air having been separated from the dust-containing air to the electric blower 8. The electric blower 8 discharges the air sucked from the dust separation device 7 to the outside of the cleaner body 2. Hereinafter, such a cleaning function of the electric vacuum cleaning apparatus 1 is referred to as “the suction cleaning function” or simply referred to as “the suction cleaning”.

In addition, when the sterilization switch 24d is turned on, the electric vacuum cleaning apparatus 1 supplies power to the electrolyzed-water generator 42 and causes the electrolyzed-water generator 42 to generate electrolyzed water. The electric vacuum cleaning apparatus 1 atomizes the electrolyzed water so as to spray or spread the atomized electrolyzed water onto the surface to be cleaned when moving along with the cleaning. When the supply of power to the electrolyzed water generator 42 is enabled (for example, when the plug 14 is connected to the wiring plug connector or when the start switch 24b is operated), the electric vacuum cleaning apparatus 1 may supply power to the electrolyzed water generator 42 in advance so as to cause the electrolyzed water generator 42 to start electrolysis of water. In such a case, the electric vacuum cleaning apparatus 1 can immediately start supplying the electrolyzed water having been already generated when the sterilization switch 24d is turned on.

When the sterilization switch 24d is turned off, the electric vacuum cleaning apparatus 1 stops the power supply to the electrolyzed-water generator 42, stops water electrolysis, and stops spraying or spreading electrolyzed water onto the surface to be cleaned.

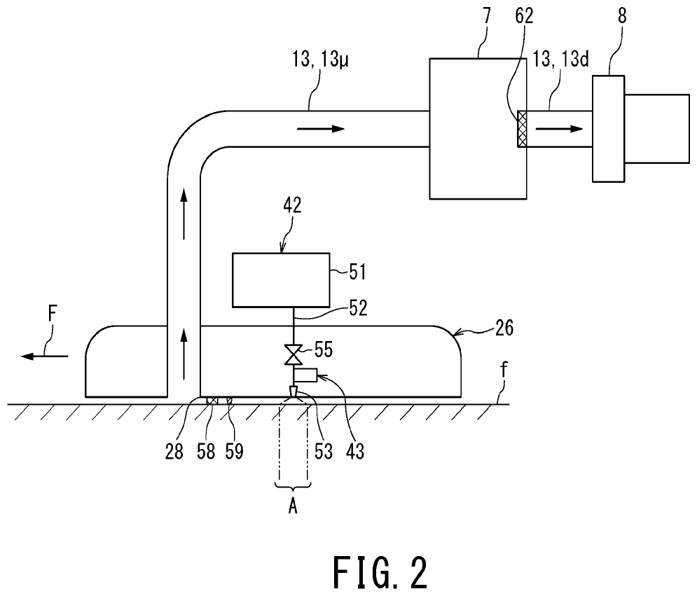

FIG. 2 is a schematic diagram mainly illustrating air passages and its peripheral components of the electric vacuum cleaning apparatus shown in FIG. 1.

The cleaning head 26 of the electric vacuum cleaning apparatus 1 is provided with the electrolyzed-water generator 42 and an atomizer that atomizes the electrolyzed water produced with the electrolyzed-water generator 42 and then supplies the atomized electrolyzed-water to the surface to be cleaned. Hereinafter, the surface to be cleaned referred to as the cleaning-target surface f.

When the hose 3 is attached to the cleaner body 2, the suction port 28 corresponds to the entrance of the suction air passage 13, i.e., the most upstream end of the suction air passage 13. The electric vacuum cleaning apparatus 1 sucks in dust from the suction port 28 of the cleaning head 26.

The suction air passage 13 includes an upstream air passage 13u from the suction port to the dust separation device 7, and a downstream air passage 13d from the dust separation device 7 to the electric blower 8.

As to generation of electrolyzed water, for example, the electrolyzed-water generator 42 electrolyzes water so as to produce electrolyzed water in which ozone is dissolved or electrolyzes salt water (i.e., brine) so as to produce electrolyzed water in which hypochlorous acid (HClO) is dissolved. In Japan, according to the Water Supply Law, tap water readily available at home contains chlorine. In Japan, according to Article 17 third of the Water Supply Law Enforcement Regulations (Ministry of Health, Labor and Welfare ordinance) based on the Water Supply Law Article 22, the concentration of chlorine in tap water is regulated to 1/10 ppm (parts per million by mass or milligrams per liter) or more. The electrolyzed-water generator 42 can readily produce electrolyzed water containing hypochlorous acid by electrolyzing water containing chlorine like the tap water in Japan or an aqueous solution in which chloride is dissolved. The chloride may be, for example, salt which is readily available at home. That is, the aqueous solution in which chloride is dissolved may be salt water. The electrolyzed-water generator 42 includes: a reservoir 51 capable of storing water; electrodes including an anode and a cathode; and a power supply circuit configured to apply voltage to the electrodes by using the power supplied through the power cord 11.

The reservoir 51 is a container for storing water or salt water. The water stored in the reservoir 51 may be tap water. In order to enhance the convenience of water supply, it is preferred that the reservoir 51 is detachable from the cleaner body 2. The reservoir 51 has a lid that can be opened and closed. The reservoir 51 can readily supply water or salt water by opening its lid.

A material that barely dissolves in water, such as titanium or platinum, is used as the electrode material of the electrolyzed-water generator. In order to promote electrolysis, a platinum group metal such as iridium, platinum, and ruthenium may be supported on the electrodes or the oxide of the platinum group metal may be supported on the electrodes. Chemical species such as hydrogen peroxide, active oxygen and OH radicals are produced in the electrolyzed water.

The electrodes are provided in the reservoir 51. The electrodes may be provided outside the reservoir 51, for example, in a pipe connecting the reservoir 51 and the atomizer 43. That is, the electrolyzed-water generator 42 may be a device that electrolyzes the water in the reservoir 51 into electrolyzed water. Additionally or alternatively, the electrolyzed-water generator 42 may be a device that electrolyzes water supplied from the reservoir 51 to the atomizer 43 into electrolyzed water before the water reaches the atomizer 43, i.e., in the process of reaching the atomizer 43.

The electrolyzed-water generator 42 may be a single-chamber type that does not include a partition between the anode and the cathode or may be a multi-chamber type having a partition between the anode and the cathode. The multi-chamber type electrolyzed-water generator includes a two-chamber type, a three-chamber type, or more. The single-chamber electrolyzed-water generator 42 neutralizes the acidic ion water to be produced on the anode side and the alkaline ion water to be produced on the cathode side so as to produce electrolyzed water containing hypochlorous acid at an appropriate concentration. The multi-chamber electrolyzed-water generator 42 produces acidic ion water in the chamber accommodating the anode and produces alkaline ion water in the chamber accommodating the cathode.

In the case of the multi-chamber electrolyzed-water generator 42, there is a possibility that the amount of acid ion water being used and the amount of alkaline ion water being used becomes uneven, and this unevenness causes a burden to dispose of the remaining ion water. The single-chamber electrolyzed-water generator 42 eliminates the burden to dispose of the remaining ion water like the multi-chamber type, and may be more convenient for a user than the multi-chamber type.

The electrolyzed-water generator 42 has the ability to produce electrolyzes water with hypochlorous-acid concentration of 5 ppm or more by electrolyzing water with chlorine concentration of 1/10 ppm or more (i.e., water compatible with the tap water in the Japanese Water Supply Law). If chlorine concentration of the tap water is so low that production of electrolyzed water with hypochlorous-acid concentration of 5 ppm or more is difficult even by electrolyzing the tap water, such electrolyzed water can be produced by dissolving chloride such as salt in the tap water.

The atomizer 43 uses various atomization methods. The atomization methods includes: a heating method in which the electrolyzed water produced by the electrolyzed-water generator 42 is heated to be atomized; an ultrasonic method in which the electrolyzed water produced by the electrolyzed-water generator 42 is vibrated to be atomized; a method in which the electrolyzed water produced by the electrolyzed-water generator 42 is atomized with a spray with a venturi effect (for example, mist blowing); an electrostatic atomization in which the electrolyzed water produced by the electrolyzed-water generator 42 is atomized by applying corona discharge; and a water-crushing method in which, for example, a propeller rotating at high speed is used for crushing the electrolyzed water and thereby the electrolyzed water is atomized. In any one of the atomization methods, the atomizer 43 atomizes electrolyzed water such that fine particles less than 100 micrometers in diameter, more preferably, less than 10 micrometers in diameter are contained in the atomized electrolyzed water.

The atomizer 43 is provided in the cleaning head 26. The atomizer 43 sprays or spreads the atomized electrolyzed water from the bottom face of the cleaning head 26 to the surface to be cleaned facing the bottom face. The atomizer 43 includes; a pipe 52 connected to the electrolyzed-water generator 42; a supply port 53 that is disposed on the bottom face of the cleaning head 26 and discharges mist of the electrolyzed water; and a valve 55 provided in the middle of the pipe 52.

The atomizer 43 supplies electrolyzed water to the cleaning-target surface f through which the suction port 28 has passed (i.e., to the cleaning-target surface f from which dust has been removed by being sucked into the suction port 28). Specifically, the supply port 53 of the atomizer 43 is disposed behind the suction port 28 in the advancing direction of the cleaning head 26 (solid arrow F in FIG. 1 and FIG. 2). That is, the atomizer 43 supplies the electrolyzed water to part of the surface f to be cleaned after suction cleaning is performed by the suction vacuum pressure generated with the electric blower 8.

The supply port 53 is, for example, a nozzle capable of spraying or spreading electrolyzed water. The electric vacuum cleaning apparatus 1 may include a plurality of supply ports 53. For example, the supply ports 53 are preferably arranged in a row in the width direction of the cleaning head 26, i.e., in the width direction of the suction port 28. The supply ports 53 arranged in the above manner sprays or spreads electrolyzed water over a wider area as the suction port 28 advances. In addition, the supply port 53 may be an elongated flat nozzle having a long side in the width direction of the cleaning head 26.

The valve 55 is provided in the middle of the pipe 52, and performs both of supply of electrolyzed water to the supply port 53 and shut-off of the supply of electrolyzed water. The valve 55 is, for example, a solenoid valve. The opening and closing of the valve 55 is interlocked with the permission or non-permission of producing electrolyzed water in the electrolyzed-water generator 42. In detail, the valve 55 is opened at the same time as the sterilization switch 24d is turned on and power is supplied to the electrolyzed-water generator 42. Alternatively, the valve 55 is opened after a predetermined time (for example, 5 seconds) elapses in anticipation of the time until electrolyzed water is produced in the electrolyzed-water generator 42. The valve 55 is closed at the same time as the sterilization switch 24d is turned off and power supply to the electrolyzed-water generator 42 is stopped.

The inventors have found that the surface to be cleaned can be sufficiently sterilized by spraying or spreading electrolyzed water containing hypochlorous-acid having a concentration of 5 ppm or more to the cleaning-target surface f at a supply rate of 1/10 microliters or more per square centimeter. For this reason, the atomizer 43 atomizes electrolyzed water continuously in such a manner that the electrolyzed water at a supply rate of 1/10 microliter per square centimeter or more can be sprayed or spread to the cleaning-target surface f.

For example, as described in Appendix C of JIS C 9108, the method of measuring performance on a carpet floor surface, the moving speed of the cleaning head 26, i.e., the moving speed of the atomizer 43 is assumed to be 50 centimeters per second, and the spraying width or spread width of electrolyzed water is assumed to be 25 cm. The spread width of electrolyzed water means the width of electrolyzed water to be spread in the direction orthogonal to the traveling direction of the atomizer 43, i.e., means the width of electrolyzed water to be spread in the direction orthogonal to the traveling direction of the cleaning head 26. Under the above-described assumption, in order to spray or spread electrolyzed water onto the cleaning-target surface f at a supply rate of 1/10 microliter per square centimeter or more, the atomizer 43 is required to supply electrolyzed water at a supply rate of 125 microliters per second or more. Although the moving speed of the atomizer 43 (i.e., the moving speed of the cleaning head 26) is not constant in actual use, in the case of using the above values for one reference or standard, the atomizer 43 preferably supplies electrolyzed water at a supply rate of 125 microliters per second or more.

The cleaning head 26 includes a wiper 58 that can wipe off electrolyzed water. This wiper 58 is disposed between the suction port 28 and the supply target position of electrolyzed water from the supply port 53 to the surface f to be cleaned when the cleaning head 26 is placed on the cleaning-target surface f.

The supply target position of electrolyzed water from the supply port 53 to the surface f to be cleaned means a spread region A of electrolyzed water in the surface f to be cleaned as shown in FIG. 2.

In detail, the wiper 58 is provided closer to the suction port 28 than the spread region A. The wiper 58 is, for example, a brush, a woven fabric, or a non-woven fabric. The material of the wiper 58 is synthetic fiber that includes natural fiber such as cotton, regenerated fiber such as cellulose, polyester fiber, polyamide fiber such as nylon 6, nylon 66, and nylon 46, and polyolefin fiber such as polyethylene and polypropylene. The wiper 58 may be a sponge. In addition, the wiper 58 may integrally include a member made of super absorbent polymer (SAP). The SAP is so-called absorbent polymer, superabsorbent resin, or polymer absorber. The wiper 58 integrally provided with a member made of SAP can hold a larger amount of electrolyzed water.

The wiper 58 may be attachable to and detachable from the cleaning head 26. Additionally, it is preferred that the wiper 58 extends continuously over the entire width of the opening width of the suction port 28.

The wiper 58 wipes the electrolyzed water approaching the suction port 28 with movement of cleaning head 26, particularly the electrolyzed water remaining on the surface to be cleaned, form the surface to be cleaned before reaching the suction port 28.

Instead of or in addition to the wiper 58, the cleaning head 26 may be provided with a shield 59 that is disposed between the suction port 28 and the supply point of the electrolytic water from the supply port 53 to the cleaning-target surface f when the cleaning head 26 is placed on the cleaning-target surface f. This shield 59 prevents the electrolytic water from being sucked into the suction port 28 due to suction vacuum pressure.

The shield 59 is provided closer to the suction port 28 than the spread region A. The shield 59 is, for example, a blade made of synthetic rubber such as natural rubber and silicone rubber. The shield 59 preferably extends continuously over the entire width of the opening of the suction port 28. The shield 59 scrapes the moisture containing the electrolyzed water remaining on the surface to be cleaned before reaching the suction port 28, like a squeegee.

It is sufficient that the cleaning head 26 is provided with any one of the wiper 58 and the shield 59. Either the wiper 58 or the shield 59 may be closer to the suction port 28. It is preferred that the wiper 58 and the shield 59 are spaced apart and arranged in parallel with each other. When the wiper 58 is closer to the suction port 28 than the shield 59, the amount of moisture to be absorbed by the wiper 58 is reduced and thus the wiping effect of the wiper 58 can be maintained longer.

The electric vacuum cleaning apparatus 1 further includes a moisture absorber 62 that is provided in the suction air passage 13 and absorbs electrolyzed water (moisture) sucked into the suction air passage 13 by suction vacuum pressure.

When electrolyzed water is sucked into the suction air passage 13, the moisture absorber 62 absorbs moisture containing electrolyzed water and prevents the moisture from reaching the electric blower 8 before the moisture reaches the electric blower 8. The moisture absorber 62 is, for example, a woven fabric or a non-woven fabric. The material of the moisture absorber 62 is synthetic fiber that includes natural fiber such as cotton, regenerated fiber such as cellulose, polyester fiber, polyamide fiber such as nylon 6, nylon 66, and nylon 46, and polyolefin fiber such as polyethylene and polypropylene. The moisture absorber 62 may be a sponge. In addition, the moisture absorber 62 may be integrally provided with a member made of SAP. The moisture absorber 62 integrally provided with a member made of SAP can hold a larger amount of electrolyzed water.

The moisture absorber 62 may be provided in the upstream air passage 13u of the suction air passage 13 or in the downstream air passage 13d of the suction air passage 13. The moisture absorber 62 may be provided inside the dust separation device 7. In addition to the function of absorbing moisture, the moisture absorber 62 may also function as a filter of the dust separation device 7 that separates dust from dust-containing air having been sucked into the suction air passage 13.

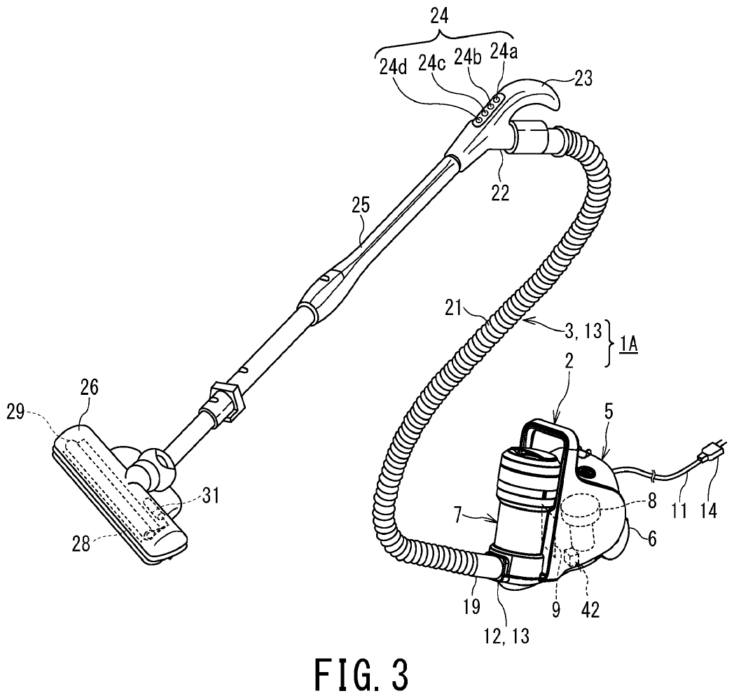

FIG. 3 is a perspective view illustrating an electric vacuum cleaning apparatus 1A of another embodiment.

The electrolyzed-water generator 42 of the electric vacuum cleaning apparatus 1A is provided, for example, in a canister type cleaner body 2. The electrolyzed-water generator 42 sprays or spreads electrolyzed water from at least one of the lower face (i.e., bottom face that faces the surface to be cleaned) and the side faces of the cleaner body 2 to the surface to be cleaned. In the canister type electric vacuum cleaning apparatus LA, the cleaner body 2 moves so as to follow the movement of a user during cleaning. This movement of the user or movement of the cleaner body 2 is substantially equivalent to the movement of the cleaning head 26. Thus, the electric vacuum cleaning apparatus 1A can spray or spread electrolyzed water onto the surface to be cleaned from which the dust has already been removed.

As described above, each of the electric vacuum cleaning apparatuses 1 and 1A includes: the electrolyzed-water generator 42 that electrolyzes water to produce electrolyzed water containing hypochlorous acid; and the atomizer 43 that atomizes the electrolyzed water produced with the electrolyzed-water generator 42 and supplies the atomized electrolyzed water to the cleaning-target surface f. Consequently, the electric vacuum cleaning apparatuses 1 and 1A can spray or spread the atomized electrolyzed water containing hypochlorous acid to the cleaning-target surface f, and thus can perform a wide range of sterilization of the surface to be cleaned along with its movement.

Additionally, the electric vacuum cleaning apparatus 1 includes the atomizer 43 provided in the cleaning head 26. Consequently, the electric vacuum cleaning apparatus 1 can collectively perform suction cleaning and sterilize on the surface to be cleaned in a range where the cleaning head 26 is moved.

Further, the electric vacuum cleaning apparatus 1A includes the atomizer 43 provided in the cleaner body 2. Consequently, the electric vacuum cleaning apparatus 1A can collectively perform suction cleaning and sterilize on the surface to be cleaned in a range where the cleaner body 2 is moved.

Moreover, each of the electric vacuum cleaning apparatuses 1 and 1A includes the atomizer 43 that supplies electrolyzed water to the cleaning-target surface f through which the suction port 28 or the cleaner body 2 has already passed. Consequently, the electric vacuum cleaning apparatuses 1 and 1A can effectively sterilize the exposed or dust-free cleaning-target surface f from which the dust has been removed by suction cleaning.

Furthermore, each of the electric vacuum cleaning apparatuses 1 and 1A includes the atomizer 43 that atomizes electrolyzed water in such a manner that fine particles having a diameter of 10 micrometers or less are contained in the atomized electrolyzed water. Electrolyzed water having a diameter of 10 micrometers or less evaporates quickly after being supplied to the surface to be cleaned. Consequently, each of the electric vacuum cleaning apparatuses 1 and 1A avoids flooding the surface to be cleaned with electrolyzed water, and there is little possibility that the electrolyzed water is sucked into the suction air passage 13. For example, in a cleaning operation in which a user reciprocates the cleaning head 26 back and forth, the cleaning head 26 repeatedly moves on the same range in some cases. Even during such repeated cleaning operations, each of the electric vacuum cleaning apparatuses 1 and 1A makes it difficult for the electrolyzed water to be drawn into the suction air passage 13 by quickly vaporizing the water (electrolyzed water) on the surface to be cleaned during one reciprocation movement time of the cleaning head 26.

Additionally, each of the electric vacuum cleaning apparatuses 1 and 1A includes the atomizer 43 that atomizes electrolyzed water continuously. Consequently, the electric vacuum cleaning apparatuses 1 and 1A can continuously supply electrolyzed water to the surface to be cleaned and can supply electrolyzed water over a wide range.

Further, each of the electric vacuum cleaning apparatuses 1 and 1A includes the electrolyzed-water generator 42 that has the ability to produce electrolyzed water with hypochlorous-acid concentration of 5 ppm or more by electrolyzing water containing chlorine. For example, in areas where the tap water with chlorine concentration of 1/10 ppm or more can be readily obtained, as in Japan having the above-described Water Supply Law, each of the electric vacuum cleaning apparatuses 1 and 1A can readily produce electrolyzed water with hypochlorous-acid concentration of 5 ppm or more, which is sufficiently effective in sterilizing the surface to be cleaned, so as to supply it to the surface to be cleaned. Even in areas where chlorine concentration of the tap water is so low that production of electrolyzed water with hypochlorous acid concentration of 5 ppm or more is difficult even by electrolyzing the tap water, the above described-effect can also be obtained in the following manner. In such areas, each of the electric vacuum cleaning apparatuses 1 and 1A can readily produce electrolyzed water with hypochlorous-acid concentration of 5 ppm or more, which is sufficiently effective in sterilizing the surface to be cleaned, by dissolving salt being readily available at home in the tap water and can supply the produced electrolyzed water to the surface to be cleaned.

Moreover, each of the electric vacuum cleaning apparatuses 1 and 1A includes the atomizer 43 that atomizes electrolyzed water in such a manner that the electrolyzed water can be sprayed or spread to the cleaning-target surface f with a supply volume of 1/10 microliter per square centimeter or more. Consequently, the electric vacuum cleaning apparatus 1 and 1A can reliably sterilize the surface to be cleaned.

Furthermore, the atomizer 43 of each of the electric vacuum cleaning apparatuses 1 and 1A supplies electrolyzed water with a supply volume of 125 microliters per second or more. Consequently, the electric vacuum cleaning apparatus 1 and 1A can use a sufficient amount of electrolyzed water for cleaning or sterilization, and thus the surface to be cleaned is sterilized to every corner.

Additionally, each of the electric vacuum cleaning apparatuses 1 and 1A includes the electrolyzed-water generator 42 that is a single-chamber type without a partition between its anode and cathode. As compared with the case of adopting a multi-chamber electrolyzed-water generator that produces acidic ion water and alkaline ion water separately and may cause a burden to dispose of the remaining ion water due to difference or unevenness in consumption between both, the electric vacuum cleaning apparatuses 1 and 1A is more convenient for a user.

Further, each of the electric vacuum cleaning apparatuses 1 and 1A includes a sterilization switch 24d that receives an operation of switching between permission and non-permission of generating electrolyzed water in the electrolyzed-water generator 42. Consequently, the electric vacuum cleaning apparatus 1 and 1A can readily switch between implementation and non-implementation of sterilizing the surface to be cleaned with the use of electrolyzed water depending on the user's intention.

Therefore, according to the electric vacuum cleaning apparatuses 1 and 1A of the above-described embodiments, it is possible to disinfect the surface to be cleaned by atomizing electrolyzed water containing hypochlorous acid and spraying or spreading the atomized electrolyzed water to this surface while moving on this surface.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electric vacuum cleaning apparatus comprising:
an electric blower that generates suction vacuum pressure;
a suction air passage equipped with a suction port and fluidly connected to a suction side of the electric blower;
an electrolyzed-water generator that electrolyzes water to produce electrolyzed water containing hypochlorous acid; and
an atomizer that atomizes the electrolyzed water produced with the electrolyzed-water generator and supplies the atomized electrolyzed water to a surface to be cleaned.

2. The electric vacuum cleaning apparatus according to claim 1, wherein the atomizer is provided with a cleaning head in which the suction port is included.

3. The electric vacuum cleaning apparatus according to claim 1, wherein the atomizer is provided in a cleaner body that accommodates the electric blower.

4. The electric vacuum cleaning apparatus according to claim 2, wherein the atomizer is configured to supply the electrolyzed water to part of the surface to be cleaned after suction cleaning is performed by the suction vacuum pressure generated with the electric blower.

5. The electric vacuum cleaning apparatus according to claim 1, wherein the atomizer is configured to atomize the electrolyzed water in such a manner that particles having a diameter of 10 micrometers or less are contained.

6. The electric vacuum cleaning apparatus according to claim 1, wherein the atomizer is configured to atomize the electrolyzed water continuously.

7. The electric vacuum cleaning apparatus according to claim 1, wherein the electrolyzed-water generator has ability to produce electrolyzed water with hypochlorous-acid concentration of 5 ppm (parts per million by mass) or more by electrolyzing water.

8. The electric vacuum cleaning apparatus according to claim 1, wherein the atomizer is configured to atomize the electrolyzed water in such a manner that the electrolyzed water can be sprayed or spread to the surface to be cleaned at a supply rate of 1/10 microliter per square centimeter or more.

9. The electric vacuum cleaning apparatus according to claim 1, wherein the atomizer is configured to supply the electrolyzed water at a supply rate of 125 microliter per second or more.

10. The electric vacuum cleaning apparatus according to claim 1, wherein the electrolyzed-water generator is a single-chamber type without a partition between an anode and a cathode.

11. The electric vacuum cleaning apparatus according to claim 1, further comprising an input unit configured to receive an operation of switching between permission and non-permission of generating the electrolyzed water in the electrolyzed-water generator.

12. The electric vacuum cleaning apparatus according to claim 3, wherein the atomizer is configured to supply the electrolyzed water to part of the surface to be cleaned after suction cleaning is performed by the suction vacuum pressure generated with the electric blower.

13. The electric vacuum cleaning apparatus according to claim 5, wherein the electrolyzed-water generator has ability to produce electrolyzed water with hypochlorous-acid concentration of 5 ppm (parts per million by mass) or more by electrolyzing water.

14. The electric vacuum cleaning apparatus according to claim 13, wherein the atomizer is configured to atomize the electrolyzed water in such a manner that the electrolyzed water can be sprayed or spread onto the surface to be cleaned at a supply rate of 1/10 microliter per square centimeter or more.

15. The electric vacuum cleaning apparatus according to claim 14, wherein the atomizer is configured to supply the electrolyzed water at a supply rate of 125 microliter per second or more.
